(19) United States
(12) Patent Application Publication
(10) Pub. No.: US 2012/0279219 A1
(43) Pub. Date: Nov. 8, 2012

(54) COMBUSTION ENGINE AND MOTOR VEHICLE

(75) Inventor: Kurt KAUTZMANN, Gross-Rohrheim (DE)

(73) Assignee: GM GLOBAL TECHNOLOGY OPERATIONS LLC, Detroit, MI (US)

(21) Appl. No.: 13/463,943

(22) Filed: May 4, 2012

(30) Foreign Application Priority Data
May 6, 2011 (DE) 10 2011 100 684.6

(51) Int. Cl. F02B 37/00

(52) U.S. Cl. 60/612

(57) ABSTRACT

A combustion engine includes a first turbocharger that compresses charge air in a first compressor stage and a second turbocharger that further compresses the air compressed in the first turbocharger and that feeds the further compressed air to the combustion engine. A charge air cooler is disposed between the first and the second turbocharger and is configured to cool the air compressed by the first turbocharger.

### CROSS-REFERENCE TO RELATED APPLICATION

This application claims priority to German Patent Application No. 10 2011 100 684.6, filed May 6, 2011, which is incorporated herein by reference in its entirety.

### TECHNICAL FIELD

The technical field relates to a combustion engine and to a motor vehicle.

### BACKGROUND

In the German Patent application DE 197 06 859 A1, a combustion engine is described, which is equipped with an at least two-stage charge air compression having an intermediate cooling and an after cooling in conjunction with a following part expansion of the charge air. The compression process of the charge air is carried out in at least two stages. After the first compressor stage, heat is passed on into a charge air cooler, which serves as intermediate cooler. Following this, the already pre-compressed air is again compressed and aftercooled in a second charge air cooler. Following this, the adiabatic part expansion of the charge air takes place.

However, two charge air coolers are provided for this type of air compression, i.e. a first charge air cooler for intermediate cooling and a second charge air cooler for aftercooling. This is accompanied by additional manufacturing and assembly costs. In addition, a larger installation space is required for the two charge air coolers in the engine compartment of the motor vehicle.

At least one object herein is to provide an improved combustion engine. In addition, other objects, desirable features and characteristics will become apparent from the subsequent summary and detailed description, and the appended claims, taken in conjunction with the accompanying drawings and this background.

### SUMMARY

A combustion engine with a charge air cooling system for double-charged engines is provided. The combustion engine has a first turbocharger that compresses charge air in a first compressor stage and a second turbocharger that further compresses the air compressed in the first turbocharger in a second compressor stage and that then feeds the further compressed air to the combustion engine. A charge air cooler is disposed between the first and the second turbocharger and cools the air compressed by the first turbocharger.

A motor vehicle, in particular a passenger car, also is provided. The motor vehicle has the combustion engine described herein.

By cooling the air in following the first compressor stage, the response behavior of the combustion engine can be improved, since the second turbocharger because of the cooled air is able to compress and subsequently feed a larger quantity of air to the combustion engine. To this end, the air after it has been compressed by the first turbocharger is initially cooled before it is then fed to the second turbocharger. Because of this, the second turbocharger can compress and feed a larger quantity of air to the combustion engine. Because of this, more fuel can be fed to the combustion engine and the power of the combustion engine is increased.

In an embodiment, the first turbocharger is connected to the charge air cooler via a first pipeline in order to feed the air compressed in the first compressor stage to the charge air cooler. Because of this, the hot air compressed in the first compressor stage is initially cooled, so that the following second turbocharger can be fed with a larger quantity of air for compressing. The larger quantity of air which is compressed by the second turbocharger is then again fed to the combustion engine. A greater quantity of air fed to the combustion engine means that the combustion engine is also fed more fuel and the combustion engine achieves a greater output because of this.

In another embodiment, the charge air cooler is connected to the second turbocharger via a second pipeline, in order to feed the air compressed in the first compressor stage and the air cooled in the charge air cooler to the second turbocharger. The second turbocharger is thus able to compress a larger quantity of air since the latter was already cooled beforehand. Because of this, the output of the combustion engine is increased and its response characteristic improved accordingly.

According to a further embodiment, the second turbocharger is connected or coupled to the combustion engine via a third pipeline, in order to feed the air compressed in the second compressor stage to the combustion engine. A further cooling of the air present on the output side of the second turbocharger and prior to a feeding of the air to the combustion engine is thus not required, since the combustion engine because of the cooling of the air provided on the output side of the first compressor stage is already fed with a larger quantity of air and because of this the output of the combustion engine is already increased.

The charge air cooler and the combustion engine are interconnected via a fourth pipeline in which a valve device is arranged, in accordance with an embodiment. The valve device is designed as a non-return valve. Because of this it can be prevented that too large a quantity of air is fed to the second turbocharger for compressing. A part of the air in this case is thus fed directly to the combustion engine via the fourth pipeline.

In another embodiment, the fourth pipeline is connected between the charge air cooler and the combustion engine to the second pipeline, which connects the second turbocharger to the charge air cooler. Because of this, a part of the air if required is fed directly to the combustion engine instead of to the second turbocharger.

The first turbocharger can be connected to a suction line for sucking in air on the air inlet side, wherein in the suction line an air filter is arranged.

The two turbochargers can be arranged one after the other and can be dimensioned in such a manner that the first turbocharger compresses a larger air mass than the second turbocharger.

The above configurations and further developments can be combined as required insofar as practical. Further possible configurations, further developments and implementations also comprise not explicitly mentioned combinations of features described before in the following with respect to the exemplary embodiments. In particular, the person skilled in the art will also add individual aspects as improvements or additions to the respective basic form described herein.

### BRIEF DESCRIPTION OF THE DRAWING

The various embodiments will hereinafter be described in conjunction with the following drawing figures, wherein like numerals denote like elements, and wherein:

FIG. 1 is a schematic view of a conventional charge air cooling system of a combustion engine of a vehicle according to the prior art; and

FIG. 2 is a schematic view of a charge air cooling system of a combustion engine of a vehicle according to an exemplary embodiment.

### DETAILED DESCRIPTION

The following detailed description is merely exemplary in nature and is not intended to limit the application and uses of the various embodiments. Furthermore, there is no intention to be bound by any theory presented in the preceding background or the following detailed description.

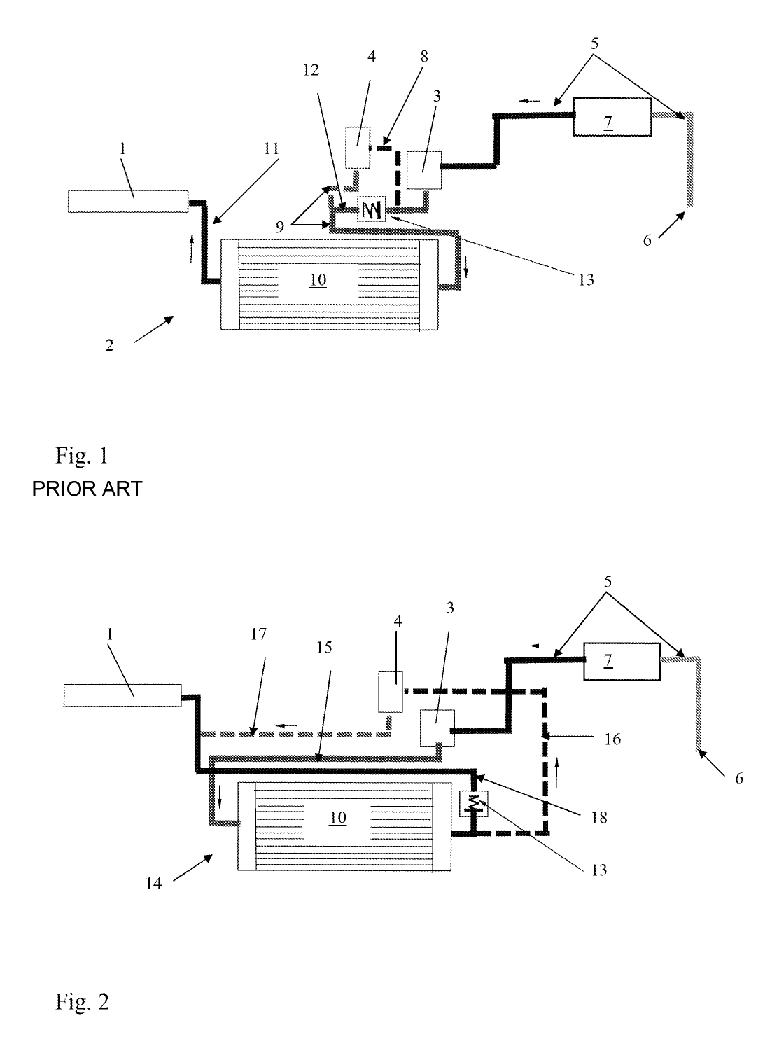

FIG. 1 shows a schematic view of a combustion engine 1 with a conventional charge air cooling system 2. The combustion engine 1 comprises a first and a second turbocharger 3, 4, which are coupled to each other. Each of the turbochargers 3, 4 comprises a turbine and a compressor. The turbine is driven by an exhaust gas stream of the vehicle and in turn drives the compressor, which compresses air and feeds it to the combustion engine 1. The two compressors of the two turbochargers 3, 4 are intended to perform a two-stage compression of air sucked in by the combustion engine 1. The compressed air is subsequently fed to the combustion engine 1 as described before.

As is shown in the exemplary embodiment in FIG. 1, the first turbocharger 1 is connected to a suction line 5, via which air is sucked into the compressor of the first turbocharger 3. The suction line 5 comprises a snorkel inlet 6 as air inlet for the sucked-in air. Between the suction line 5 and the compressor of the first turbocharger 3 an air filter 7 is additionally provided, in which the sucked-in air is initially filtered before it is fed to the compressor of the first turbocharger 3.

The compressor of the first turbocharger 3 compresses the sucked-in air in a first compressor stage. Following this, the compressed air is fed to the compressor of the second turbocharger 4 via a line 8, which connects the first and the second compressor of the two turbochargers 3, 4. In the compressor of the second turbocharger 4, the hot air is further compressed in a second compressor stage. Following this, the compressed air is fed to the charge air cooler 10 via a line 9. The line 9 connects the compressor of the second turbocharger 4 to the charge air cooler 10, in which the compressed air is cooled. Following this, the compressed and cooled air is fed to the combustion engine 1 via a line 11, which connects the charge air cooler 10 to the combustion engine 1.

As is shown in FIG. 1, the compressor of the first turbocharger 3 is additionally connected to the charge air cooler via a line 12. The line 12 branches off the line 8, which interconnects the two compresses of the turbochargers 3, 4 and is connected to the line 9, which connects the compressor of the second turbocharger 4 to the charge air cooler 10. Here, a valve device 13 is provided in the line 12 between the compressor of the first turbocharger 3 and the charge air cooler 10.

In the event that the air quantity that is compressed by the compressor of the first turbocharger 3 is too large for the compressor of the second turbocharger 4, at least a part of the air, instead of being fed to the compressor of the second turbocharger 4, can be directly conducted to the charge air cooler 10 via the line 12 and the valve device 13. Because of this, a backflow of the air in the compressor of the first turbocharger 3 can be prevented. The valve device 13, for example a non-return valve device, is opened for this purpose and lets air flow directly from the compressor of the first turbocharger 3 to the charge air cooler 10, while the valve device 13 blocks the line 12 in the opposite direction, so that air from the charge air cooler 10 cannot flow back to the compressor of the first turbocharger 3.

With the conventional system 2 shown in FIG. 1, the air sucked in by the combustion engine 1 is compressed by the compressor of the first turbocharger 3. The compressed hot air is subsequently further compressed by the compressor of the second turbocharger 4 and following this the air is cooled in the charge air cooler before being fed to the combustion engine 1. With such a conventional system 2, this results in that the engine responds relatively slowly during acceleration.

In an exemplary embodiment, a charge air cooling system 14 is therefore provided, as it is shown in the exemplary embodiment in FIG. 2, which improves the response behavior or the response characteristic of a double-charged combustion engine 1, e.g. during accelerating. The charge air cooling system 14 likewise carries out a two-stage compression of the air sucked in by the combustion engine 1.

To this end, as is shown in the exemplary embodiment in FIG. 2, the air sucked in by the combustion engine 1 is initially compressed by a compressor of a first turbocharger 3 and then cooled in a connected charge air cooler 10. Following this, the air that has been cooled and compressed in the first compressor stage is fed to a compressor of a second turbocharger 4, which is coupled to the first turbocharger 3, and the air further compressed there in a second compressor stage. The air compressed by the compressor of the second turbocharger 4 is then fed to the combustion engine 1. By cooling the air before feeding it to the compressor of the second turbocharger 4 a larger quantity of air can be fed to and compressed by the compressor of the second turbocharger 4. Because of this, the output of the combustion engine 1 can be increased and it can be fed with more fuel since a larger quantity of compressed air is made available to the combustion engine 1 by the compressor of the second turbocharger 4.

As is shown in the exemplary embodiment in FIG. 2, the first and second turbocharger 3, 4 of the combustion engine 1 are coupled together. Both turbochargers 3, 4 each comprise a turbine and a compressor. Here, the turbine, as described before, is driven by an exhaust gas stream of the vehicle and in turn drives the compressor, which compresses air sucked in by the combustion engine 1, subsequently feeding it to the combustion engine 1. The two compressors of the turbochargers 3, 4 are provided for a two-stage compression of the air sucked in by the combustion engine 1.

The compressor of the first turbocharger 3 is connected to a suction line 5 via which air is sucked in. Here, an air filter 7 for example is additionally provided in the suction line 5 before the compressor of the first turbocharger 3 in order to filter the air before it is fed to the compressor. The part of the suction line 5 before the air filter comprises for example a snorkel inlet 6 in the exemplary embodiment in FIG. 2.

After the air has been compressed in the compressor of the first turbocharger 3, it is fed to and cooled in the charge air cooler 10 via a line 15, which connects the compressor to the charge air cooler 10. Following this, the air that has been cooled and compressed in the first compressor stage is fed to the compressor of the second turbocharger 4 via a line 16, which connects the charge air cooler 10 to the compressor of the second turbocharger 4. The compressor of the second turbocharger 4 further compresses the air in a second compressor stage 4, finally feeding the compressed air to the combustion engine 1 via a line 17. The compressor of the second turbocharger 4 is connected to the combustion engine 1 via the line 17.

Furthermore, an additional line 18 can be provided between the charge air cooler 10 and the combustion engine 1, wherein in the line 18 a valve device 13 is provided, for example a non-return valve device. The line 18 branches off the line 16, which connects the charge air cooler 10 to the compressor of the second turbocharger 4.

The purpose of the line 18 and the valve device 13 is that in the case of too large an air quantity, the latter can be at least partially fed directly to the combustion engine 1 via the line 18, without being compressed in the compressor of the second turbocharger 4 beforehand. The valve device 13 to this end opens the line 18 in the direction of the combustion engine 1, while it blocks the line 18 in the direction of the charge air cooler 10 so that no air can flow back from the combustion engine 1 into the charge air cooler 10.

The first turbocharger 3 in the exemplary embodiment shown in FIG. 2 is for example dimensioned larger than the second turbocharger 4. However, both turbochargers 3, 4 can for example be dimensioned identical in size.

By initially cooling the hot air compressed by the first turbocharger 3 in a cooling device 10, such as a charge air cooler 10 before it is fed to the second turbocharger 4, a larger quantity of air can fed to the second turbocharger 4 and compressed by the latter and made available to the combustion engine 1. The cooled charge air in the second turbocharger 4 improves the response behavior of the turbocharger 4. A reduced air volume between the second turbocharger 4 and the suction line 5 likewise further improves the response behavior of the engine 1.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A combustion engine comprising:
a first turbocharger that compresses charge air in a first compressor stage;
a second turbocharger that further compresses the charge air compressed in the first turbocharger and that feeds the further compressed charge air to the combustion engine; and
a charge air cooler disposed between the first and the second turbocharger and configured to cool the charge air compressed by the first turbocharger.

2. The combustion engine according to claim 1, wherein the first turbocharger is connected to the charge air cooler via a first pipeline.

3. The combustion engine according to claim 2, wherein the charge air cooler is connected to the second turbocharger via a second pipeline.

4. The combustion engine according to claim 3, wherein the second turbocharger is connected to the combustion engine via a third pipeline.

5. The combustion engine according to claim 4, wherein the charge air cooler and the combustion engine are interconnected via a fourth pipeline, in which a valve device is arranged.

6. The combustion engine according to claim 5, wherein the valve device is a non-return valve.

7. The combustion engine according to claim 5, wherein the fourth pipeline is connected to the second pipeline.

8. The combustion engine according to claim 1, wherein the first turbocharger is connected to a suction line for sucking-in air on an air inlet side, wherein in the suction line an air filter is arranged.

9. The combustion engine according to claim 1, wherein the first turbocharger is configured to compress a larger quantity of air than the second turbocharger.

10. A motor vehicle with a combustion engine comprising:
a first turbocharger that compresses charge air in a first compressor stage;
a second turbocharger that further compresses the charge air compressed in the first turbocharger and that feeds the further compressed charge air to the combustion engine; and
a charge air cooler disposed between the first and the second turbocharger and configured to cool the charge air compressed by the first turbocharger.

11. The motor vehicle according to claim 10, wherein the first turbocharger is connected to the charge air cooler via a first pipeline.

12. The motor vehicle according to claim 11, wherein the charge air cooler is connected to the second turbocharger via a second pipeline.

13. The motor vehicle according to claim 12, wherein the second turbocharger is connected to the combustion engine via a third pipeline.

14. The motor vehicle according to claim 13, wherein the charge air cooler and the combustion engine are interconnected via a fourth pipeline, in which a valve device is arranged.

15. The motor vehicle according to claim 14, wherein the valve device is a non-return valve.

16. The motor vehicle according to claim 14, wherein the fourth pipeline is connected to the second pipeline.

17. The motor vehicle according to claim 10, wherein the first turbocharger is connected to a suction line for sucking-in air on an air inlet side, wherein in the suction line an air filter is arranged.

18. The motor vehicle according to claim 10, wherein the first turbocharger is configured to compress a larger quantity of air than the second turbocharger.
